(19) United States
(12) Patent Application Publication
(10) Pub. No.: US 2008/0170185 A1
(43) Pub. Date: Jul. 17, 2008

(54) Liquid crystal display device and method of making the same

(76) Inventor: Ghang Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/007,770

(22) Filed: Jan. 15, 2008

(30) Foreign Application Priority Data
Jan. 16, 2007 (KR) 10-2007-0004811

(51) Int. Cl. G02F 1/1335

(52) U.S. Cl. 349/99; 349/186; 349/96

(57) ABSTRACT

A liquid crystal display device, including a twisted nematic liquid crystal layer between first and second substrates, a first polarizer disposed at the first substrate, and a second polarizer disposed at the second substrate, wherein an optical transmittance axis of one of the first and second polarizers is within a liquid crystal twist angle range of the twisted nematic liquid crystal layer.

### BACKGROUND OF THE INVENTION

1. Field of the Invention

Embodiments relate to a liquid crystal display (LCD) device and a method of making the same. More particularly, embodiments relate to a twisted nematic (TN) mode LCD device with an improved inversion viewing angle, and a method of making the same.

2. Description of the Related Art

A LCD device utilizes electric-optical characteristics in order to display images and characters. LCD devices may be classified into absorption types, scattering types, reflection types, and polarization modulation types. Among them, the reflection types and the polarization modulation types have been mainly used.

A polarization modulation type LCD device may be divided into a TN mode employing a TN liquid crystal and an electrically controlled birefringence (ECB) mode electrically changing optical retardation to adjust light transmittance. The TN mode and the ECB modes may each be divided into a normally-white mode and a normally-black mode.

The normally-white mode may be a mode in which an initial light transmittance has a maximum value when no voltage is applied. The normally-white mode may have advantageous high transmittance. However, when images having many dark gradations are produced, power consumption may be high. In contrast, the normally-black mode may have a minimum initial light transmittance when a voltage is not applied. When a dark gradation is displayed, power consumption may be low. However, transmittance may be relatively lower in comparison with the normally-white mode.

The TN mode type LCD device may be viewed as a typical example of a polarization modulation type LCD device. Since the TN mode type LCD device may be easily manufactured, may have a high response speed, and may have a high contrast ratio, it may display all screen types including still screens and a moving images.

However, the TN mode LCD device has a viewing angle difference arising from a direction of an optical path with respect to a tilt direction of rod-shaped liquid crystals. When viewing a screen from a front side, a normal screen having a high color reproduction rate may be displayed. However, when viewing the screen from an upper side or a lower side, i.e., at an angle, the same color reproduction as that of the front side may not be produced, and it may become significantly difficult to recognize an image. This problem may make it difficult to increase the size of the screen to greater than 17 inches, and may also render it difficult to employ the LCD device to complicated portable phone devices, which may require a wide viewing angle. Manufacturing of the LCD device may be difficult, where construction of the thin film transistor may be changed, or an initial tilt angle of a liquid crystal may be adjusted. Further, a light viewing angle mode may be adopted at significant cost.

The TN mode type LCD device employing a wide viewing angle (WV) mode may have an advantageously high response speed and a high contrast ratio, and may be easily manufactured in comparison with other modes. Accordingly, the TN-WV mode type LCD device may be an attractive LCD device.

In the TN-WV type LCD device, a dichroic liquid crystal may be laminated at an upper portion and a lower portion of the liquid crystal layer to form a viewing angle compensation film so that a transmittance axis conforms to an orientation direction of the liquid crystal. An optical path difference according to the orientation direction of a liquid crystal, namely, the retardation, may be similarly compensated to improve the viewing angle due to a change of a luminance.

A contrast viewing angle may widen by maintaining contrast at a predetermined level according to direction. Also, an inversion viewing angle problem is a phenomenon in which an image of a dark color appears bright according to a viewing direction. When an image becomes brighter than a luminance of an intermediate gradation, the inversion viewing angle problem occurs. Although relatively simple, the inversion viewing angle problem may not be satisfactorily solved. The inversion viewing angle problem may be a more important factor than the contrast viewing angle in order to improve screen quality.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The embodiments are therefore directed to a LCD display device, which substantially overcomes one or more problems due to the limitations and disadvantages of the related art.

It is therefore a feature of an embodiment to provide a TN mode liquid crystal display device having an improved inversion viewing angle.

It is therefore a feature of another embodiment to provide a TN mode liquid crystal display device having a wide viewing angle.

At least one of the above and other features and advantages of the embodiments may be realized by providing a liquid crystal display device, including a twisted nematic liquid crystal layer between first and second substrates, a first polarizer disposed at the first substrate, and a second polarizer disposed at the second substrate. An optical transmittance axis of one of the first and second polarizers may be within a liquid crystal twist angle range of the twisted nematic liquid crystal layer.

The optical transmittance axes of the first and second polarizers may be substantially perpendicular to each other. The optical transmittance axis of the one of the first and second polarizers may be offset from endpoints of the liquid crystal twist angle range by about 45 degrees. The endpoints of the liquid crystal twist angle range may correspond to an extending direction of orientation grooves.

The liquid crystal twist angle range may be about 45 degrees to about 135 degrees, and the optical transmittance axis of one of the first and second polarizers may be about 90 degrees. The liquid crystal twist angle range may be about 0 degrees to about 90 degrees, and the optical transmittance axis of one of the first and second polarizers may be about 45 degrees.

The liquid crystal display device may further include a first orientation film on the first substrate, the first orientation film having orientation grooves extending in a first direction, and a second orientation film on the second substrate, the second orientation film having orientation grooves extending in a second direction, wherein the optical transmission axes of the first and second polarizers may form a non-zero angle with respect to the first and second directions. The non-zero angle may be about 45 degrees. The liquid crystal display device may operate in a normally white mode.

At least one of the above and other features and advantages of the embodiments may also be realized by providing a method of manufacturing a liquid crystal display device, including disposing a twisted nematic liquid crystal layer between first and second substrates, arranging a first polarizer at the first substrate, and arranging a second polarizer at the second substrate. An optical transmittance axis of one of the first and second polarizers may be within a liquid crystal twist angle range of the twisted nematic liquid crystal layer.

The optical transmittance axes of the first and second polarizers may be arranged substantially perpendicular to each other. The optical transmittance axis of the one of the first and second polarizers may be offset from endpoints of the liquid crystal twist angle range by about 45 degrees. The endpoints of the liquid crystal twist angle range may correspond to an extending direction of orientation grooves.

The liquid crystal twist angle range may be about 45 degrees to about 135 degrees, and the optical transmittance axis of one of the first and second polarizers may be arranged at about 90 degrees. The liquid crystal twist angle range may be about 0 degrees to about 90 degrees, and the optical transmittance axis of one of the first and second polarizers may be arranged at about 45 degrees.

The method may further include providing a first orientation film on the first substrate, the first orientation film having orientation grooves extending in a first direction, and providing a second orientation film on the second substrate, the second orientation film having orientation grooves extending in a second direction, wherein the optical transmission axes of the first and second polarizers may be arranged to form a non-zero angle with respect to the first and second directions.

The non-zero angle may be about 45 degrees. The liquid crystal display device may operate in a normally white mode.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a LCD device;

FIG. 2 illustrates a perspective exploded view of the LCD device of FIG. 1; and

FIG. 3 and FIG. 4 illustrate schematic views of embodiments of the LCD device of FIG. 1.

### DETAILED DESCRIPTION OF THE INVENTION

Korean Patent Application No. 2007-0004811, filed on Jan. 16, 2007, in the Korean Intellectual Property Office, and entitled: “Liquid Crystal Display Device,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. When one element is connected to another element, one element may be not only directly connected to another element but also indirectly connected to another element via another element. Irrelevant elements may be omitted for clarity. Like reference numerals refer to like elements throughout.

According to an embodiment, first and second polarizers may be formed at opposite surfaces of a liquid crystal layer so that optical transmittance axes (absorption axes) are formed substantially perpendicular to each other. The polarizers may block the transmission of all but a single plane of lightwave vibration. An optical transmittance axis of one of the first and second polarizers may have an angle within a liquid crystal twist angle range of the liquid crystal layer. The optical transmittance axis (absorption axis) of the polarizer may conform to a rotating direction of a liquid crystal. Accordingly, since luminance of a dark gradation is not brightened according to direction, an inversion viewing angle may become wider. The viewing angle may be improved to allow a wide viewing angle in the TN mode. Since the LCD device of the present embodiments may have a simple construction and may be easily manufactured, productivity may be high. Further, the LCD devices may be manufactured at low cost through a reduction in manufacturing cost.

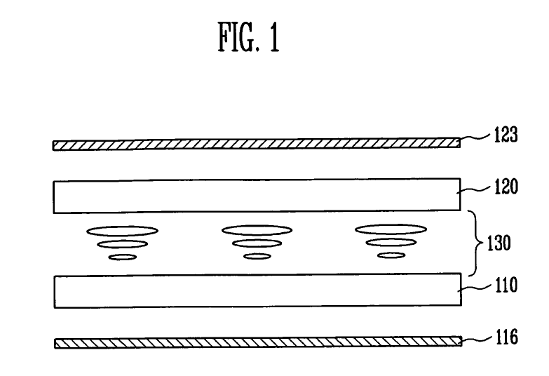

FIG. 1 illustrates a cross-sectional view of a LCD device.

The LCD device may include a lower substrate 110, an upper substrate 120, a TN liquid crystal layer 130, a first polarizer 116, and a second polarizer 123. The TN liquid crystal layer 130 may be injected between the first and second substrates 110 and 120. The first polarizer 116 may be on the lower substrate 110. The second polarizer 123 may be on the upper substrate 120.

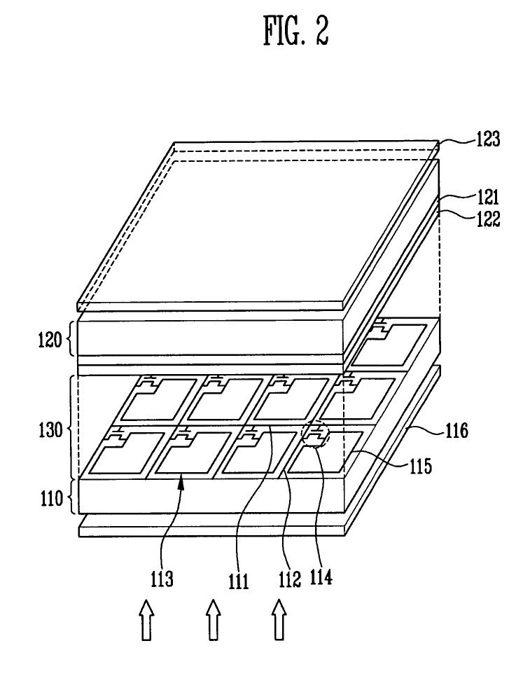

Although not shown in drawings, a back light unit may be arranged at a rear surface of the lower substrate 110. A drive integrated circuit (IC) may be mounted at the lower substrate 110 around a pixel region, and the drive IC may drive a liquid crystal. The drive IC may include a printed circuit board (PCB) and a driving circuit. Components for generating a scan signal and a data signal may be mounted on the PCB. The driving circuit may provide the generated scan signal and the data signal to gate lines 111 and data lines 112 (see FIG. 2), respectively. The drive IC may supply the scan signal and the data signal to the gate lines 111 and the data lines 112 according to an electric signal provided from an exterior through a flexible printed circuit (FPC), which may be electrically coupled to a pad portion.

FIG. 2 illustrates a perspective exploded view of the LCD device shown in FIG. 1, which schematically shows a pixel region.

Multiple gate lines 111 and multiple data lines 112 may be arranged at one surface of the lower substrate 110 in an array. A pixel region 113 may be defined by the intersecting gate lines 111 and data lines 112, and a pixel electrode 115 may be on the pixel region, which may be formed of a transparent material, e.g. indium tin oxide (ITO), indium zinc oxide (IZO), etc. A thin film transistor (TFT) 114 may be on the lower substrate 110 at an intersecting part of the gate lines 111 and the data lines 112, and the TFT may supply a signal to the pixel electrode 115. A first polarizer 116 may be installed at another surface of the lower substrate 110.

Color filters 121 and a common electrode 122 may be formed on one surface of the upper substrate 120. Red, green, and blue filters may repeat in the color filters corresponding to the pixel region 113. The common electrode 122 may be made of a transparent material, e.g., ITO, IZO, etc. A second polarizer 123 may be formed at another surface of the upper substrate 120.

The lower substrate 110 and the upper substrate 120 may face each other, and the TN liquid crystal layer 130 may be injected between the lower substrate 110 and the upper substrate 120. The TN liquid crystal layer 130 may be, e.g., a TN mode liquid crystal having a twist angle of about 90 degrees.

An angle of first orientation grooves and an angle of second orientation grooves may determine the twist angle of the liquid crystal. The first orientation grooves may be formed on a first orientation film on the lower substrate 110 by, e.g., a rubbing process. The second orientation grooves may be similarly formed on a second orientation film on the upper substrate 120. When orientation grooves of 45 degrees are formed on the first orientation film on the lower substrate 110, and orientation grooves of 135 degrees are formed on the second orientation film on the upper substrate 120, the liquid crystal twist angle range may have endpoints at 45 degrees and 135 degrees, i.e., the range may be 45 degrees to 135 degrees, and the liquid crystal may have a twist of 90 degrees.

The first polarizer 116 and the second polarizer 123 may transmit light in a polarized direction. One of the first polarizer 116 and the second polarizer 123 may have an optical transmittance axis having an angle within the liquid crystal twist angle range of the liquid crystal layer 130. The optical transmittance axes of the first and second polarizers 116 and 123 may be arranged substantially perpendicular to each other, i.e., the first and second polarizers 116 and 123 may be crossed.

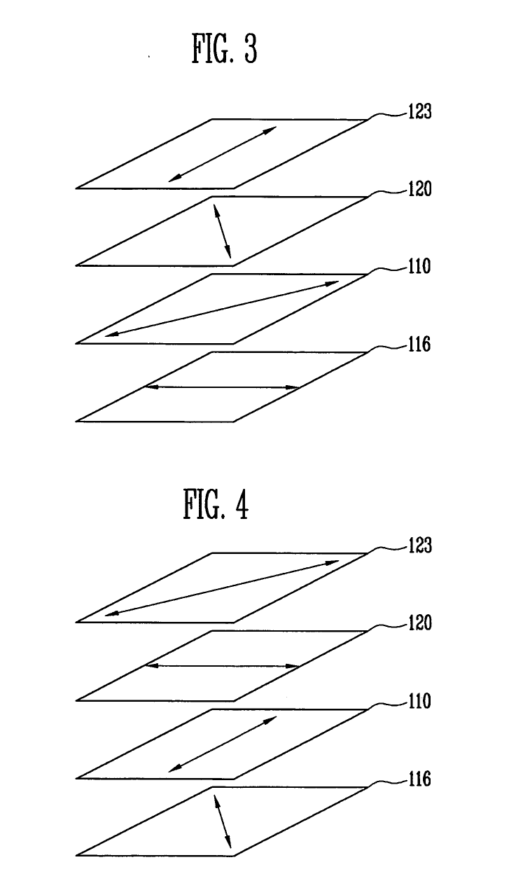

In an implementation, referring to FIG. 3, the first orientation film on the lower substrate 110 may have the first orientation grooves aligned at 45 degrees, and the second orientation film on the upper substrate 120 may have the second orientation grooves aligned at 135 degrees, such that the liquid crystal twist angle range of the liquid crystal layer 130 may be about 45 degrees to about 135 degrees. The optical transmittance axis of the first polarizer 116 may be between 45 degrees and 135 degrees, e.g., about 90 degrees. The optical transmittance axis of the second polarizer 123 may be, e.g., about 0 degrees, i.e., perpendicular to the optical transmittance axis of the first polarizer 116.

In another implementation, referring to FIG. 4, the first orientation film on the lower substrate 110 may have the first orientation grooves aligned at 0 degrees, and the second orientation film on the upper substrate 120 may have the second orientation grooves aligned at 90 degrees, such that the liquid crystal twist angle range of the liquid crystal layer 130 may be about 0 degrees to about 90 degrees. The optical transmittance axis of the first polarizer 116 may be e.g., about 135 degrees, and the optical transmittance axis of the second polarizer 123 may range from about 0 degrees to about 90 degrees, e.g., about 45 degrees.

When electric field is applied to the liquid crystal layer 130 by a voltage applied to the pixel electrode 115 and the common electrode 122, although light provided from the back light unit may transmit through the liquid crystal layer, the light may be cut off by the second polarizer 123. When an electric field is not applied to the liquid crystal layer 130, light provided from the back light unit may transmit through the liquid crystal layer 130 and the second polarizer 123, and may be output to an exterior of the LCD device. The LCD device may thus operate in the normally white mode.

Because the optical transmittance axis of the first polarizer 116 or the second polarizer 123 may have an angle within a liquid crystal twist angle range of the liquid crystal layer 130, the optical transmittance axis (absorption axis) of the first polarizer 116 or the second polarizer 123 may conform to a rotation direction of the liquid crystal of the liquid crystal layer 130, thereby widening the inversion viewing angle.

Conventionally, a polarizer may have an optical absorption axis aligned with endpoints of the twist angle range of the liquid crystal, e.g., the polarizer may have an optical absorption axis of 45 degrees (or 135 degrees) when the twist angle range is from 45 to 135 degrees. However, the optical absorption axes may not conform to each other, and that the inversion viewing angle may be narrow.

In contrast to the conventional LCD, according to an embodiment, the first or second polarizer 116 or 123 may have an optical absorption axis that is oriented at an angle within the twist angle range of the liquid crystal layer. For example, the first or second polarizers 116 or 123 may have an absorption axis of, e.g., about 90 degrees when the twist angle of the liquid crystal ranges from about 45 to about 135 degrees. Since the optical absorption axes may not conform to each either, the luminance of a dark gradation may not be lightened, and the inversion viewing angle may be wider than that of the conventional LCD.

Referring to FIG. 3, when orientation grooves of, e.g., about 45 or about 135 degrees are formed on the first orientation film on the lower substrate 110, and orientation grooves of, e.g., about 135 or about 45 degrees are formed on the second orientation film on the upper substrate 120, the twist angle of the liquid crystal may be about 90 degrees according to characteristics of the TN mode. When an optical absorption axis of the second polarizer 123 is, e.g., about 90 degrees, the optical absorption of the second polarizer 123 may conform to the twist direction of the liquid crystal. Accordingly, an inversion phenomenon at about 90 degrees may be substantially reduced, thereby significantly widening the inversion view angle.

With reference to FIG. 4, when orientation grooves of, e.g., about 90 or about 0 degrees are formed on the first orientation film on the lower substrate 110, and orientation grooves of, e.g., about 0 or about 90 degrees are formed on the second orientation film on the upper substrate 120, the twist angle of the liquid crystal may be about 90 degrees due to characteristics of the TN mode. When the optical absorption axis of the second polarizer 123 is, e.g., about 45 degrees or about 135 degrees, the optical absorption axis of the second polarizer 123 may conform to the twist direction of the liquid crystal. Accordingly, the inversion phenomenon at, e.g., about 90 degrees, may be reduced to significantly widen the inversion viewing angle.

Table 1 shows measured result of inversion viewing angles in the TN-WV normal mode, in an in-plane-switching (IPS) mode, a vertical alignment (VA) mode, and according to the present embodiments, when a dark color is displayed when orientation grooves of 45 degrees are formed on an orientation film on a lower substrate 110, and orientation grooves of 135 degrees are formed on an orientation film on an upper substrate 120.

TABLE 1

| | TN-WV | | | The present |
|---|---|---|---|---|
| Angle | normal | IPS | VA | embodiments |
| (degrees) | (degrees) | (degrees) | (degrees) | (degrees) |
| 90 | 30 | 70 or greater | 70 or greater | 70 or greater |
| 0 | 70 or greater | 70 or greater | 70 or greater | 70 or greater |
| 180 | 65 | 65 | 70 or greater | 70 or greater |
| 270 | 70 | 70 or greater | 70 or greater | 70 or greater |

Data of the table 1 is acquired by measuring respectively inversion viewing angles of LCD products of the 4 mode using viewing-angle-measuring apparatus, DMS-501 of Autronics. The inversion viewing angle is the minimum angle between a photo detector of the viewing-angle-measuring apparatus and a perpendicular line of the LCD for measuring, when the brightness of detected image by the photo detector is inverted.

In Table 1, for the present embodiments, an inversion viewing angle may be widened greater than 40 degrees in comparison to the TN-WV normal mode. The present embodiments may be at a similar or same level as the IPS or the VA mode, which is referred to as a “wide view angle.”

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A liquid crystal display device, comprising:
a twisted nematic liquid crystal layer between first and second substrates;
a first polarizer disposed at the first substrate; and
a second polarizer disposed at the second substrate,
wherein an optical transmittance axis of one of the first and second polarizers is within a liquid crystal twist angle range of the twisted nematic liquid crystal layer.

2. The liquid crystal display device as claimed in claim 1, wherein the optical transmittance axes of the first and second polarizers are substantially perpendicular to each other.

3. The liquid crystal display device as claimed in claim 1, wherein the optical transmittance axis of the one of the first and second polarizers is offset from endpoints of the liquid crystal twist angle range by about 45 degrees.

4. The liquid crystal display device as claimed in claim 3, wherein the endpoints of the liquid crystal twist angle range correspond to an extending direction of orientation grooves.

5. The liquid crystal display device as claimed in claim 1, wherein the liquid crystal twist angle range is about 45 degrees to about 135 degrees, and the optical transmittance axis of one of the first and second polarizers is about 90 degrees.

6. The liquid crystal display device as claimed in claim 1, wherein the liquid crystal twist angle range is about 0 degrees to about 90 degrees, and the optical transmittance axis of one of the first and second polarizers is about 45 degrees.

7. The liquid crystal display device as claimed in claim 1, further comprising:
a first orientation film on the first substrate, the first orientation film having orientation grooves extending in a first direction; and
a second orientation film on the second substrate, the second orientation film having orientation grooves extending in a second direction, wherein the optical transmission axes of the first and second polarizers form a non-zero angle with respect to the first and second directions.

8. The liquid crystal display device as claimed in claim 7, wherein the non-zero angle is about 45 degrees.

9. The liquid crystal display device as claimed in claim 1, wherein the liquid crystal display device operates in a normally white mode.

10. A method of manufacturing a liquid crystal display device, comprising:
disposing a twisted nematic liquid crystal layer between first and second substrates;
arranging a first polarizer at the first substrate; and
arranging a second polarizer at the second substrate,
wherein an optical transmittance axis of one of the first and second polarizers is within a liquid crystal twist angle range of the twisted nematic liquid crystal layer.

11. The method as claimed in claim 10, wherein the optical transmittance axes of the first and second polarizers are arranged substantially perpendicular to each other.

12. The method as claimed in claim 10, wherein the optical transmittance axis of the one of the first and second polarizers is offset from endpoints of the liquid crystal twist angle range by about 45 degrees.

13. The method as claimed in claim 12, wherein the endpoints of the liquid crystal twist angle range correspond to an extending direction of orientation grooves.

14. The method as claimed in claim 10, wherein the liquid crystal twist angle range is about 45 degrees to about 135 degrees, and the optical transmittance axis of one of the first and second polarizers is arranged at about 90 degrees.

15. The method as claimed in claim 10, wherein the liquid crystal twist angle range is about 0 degrees to about 90 degrees, and the optical transmittance axis of one of the first and second polarizers is arranged at about 45 degrees.

16. The method as claimed in claim 10, further comprising:
providing a first orientation film on the first substrate, the first orientation film having orientation grooves extending in a first direction; and
providing a second orientation film on the second substrate, the second orientation film having orientation grooves extending in a second direction, wherein the optical transmission axes of the first and second polarizers are arranged to form a non-zero angle with respect to the first and second directions.

17. The method as claimed in claim 16, wherein the non-zero angle is about 45 degrees.

18. The method as claimed in claim 10, wherein the liquid crystal display device operates in a normally white mode.
